(19) United States
(12) Patent Application Publication
(10) Pub. No.: US 2004/0150616 A1
(43) Pub. Date: Aug. 5, 2004

(54) Finger accessory appliance

(76) Inventor: James P. Murphy, Chicago, IL (US)

Correspondence Address: James P. Murphy, McAndrews, Held & Malloy, Ltd., 34th Floor, 500 West Madison Street, Chicago, IL, 60601, US

(21) Appl. No.: 10/355,962

(22) Filed: Jan. 30, 2003

(51) Int. Cl. G09G 5/00

(52) U.S. Cl. 345/156

(57) ABSTRACT

The present invention comprises a body adapted to snugly and removably attach to the end of a person's finger, and has an extension tip forming a blunt tip extending from the front thereof and of sufficient size to interact with prompts on a small electronic device touchscreen. This device preferably has an opening in a bottom portion to allow full finger touch sensation and to allow a user to make direct contact with any interfaces of the electronic device, such as the touchscreen, or buttons, knobs, volume control, rollers, etc. Preferably, the preferred embodiment is constructed in one piece of resilient, but inexpensive, plastic or other material for universal sizing and practicality.

### RELATED APPLICATIONS

Co-pending U.S. Design patent application Ser. No. 29/172,610, entitled “Finger Accessory Appliance,” filed on Dec. 13, 2002, under Attorney Docket No. JPM002DES.

### FEDERALLY SPONSORED RESEARCH OR DEVELOPMENT

Not Applicable

### MICROFICHE/COPYRIGHT REFERENCE

Not Applicable

### FIELD OF THE INVENTION

The present invention relates generally to an appliance to be worn on a finger to interface with electronic devices and touch screens without the burden and inconvenience of the requirement of using a separate stylus.

### BACKGROUND OF THE INVENTION

Personal electronic devices are now ubiquitous. An ever increasing percentage of people is beginning to use cell phones, personal digital assistants (“PDA's”), laptop computers, tablet PC's, and other portable electronic devices. Many of these devices offer touchscreen technology as a human interface and for data input, as well as other uses. The devices that include touchscreen technology generally require a stylus, as opposed to the naked finger, to make contact with the touchscreen. This will become ever more common as screens become ever smaller, thus requiring greater accuracy on the screen. Very often, the use of a separate stylus is difficult or impossible and reduces the usefulness of the device. A need exists for a device which offers the characteristics of a stylus and the ability to interface with a touchscreen, but without the drawbacks.

### BRIEF SUMMARY OF THE INVENTION

According to the present invention, a new and unique finger appliance is disclosed which allows a person to interface with the touchscreen of an electronic device. The present invention allows the interaction with a touchscreen and also allows interaction with the non-touchscreen interfaces of an electronic device, such as buttons and knobs. The device of the present invention also allows a user to interface with an electronic device as stated without fumbling with a stylus, because the device of the present invention may be removably attached to a user's finger without adversely affecting other normal activity.

The present invention comprises a body adapted to snugly and removably attach to the end of a person's finger, and has an extension tip forming a distal tip extending from the front thereof and of sufficient size to interact with prompts on a small electronic device touchscreen. The device has an opening in a bottom portion for normal finger functions and feel and to allow a user to make direct skin contact with any interfaces of the electronic device, such as the touchscreen, or buttons, knobs, volume control, rollers, etc. Preferably, the preferred embodiment is constructed in one piece of resilient, but inexpensive, plastic for universal sizing and practicality.

### BRIEF DESCRIPTION OF SEVERAL VIEWS OF THE DRAWINGS

FIG. 1 is a perspective view of a finger appliance according to the invention.

FIG. 2 is a top plan view of the appliance of FIG. 1.

FIG. 3 is a front elevation view of the appliance of FIG. 1.

FIG. 4 is a right side elevation view of the appliance of FIG. 1 showing in phantom (and not forming a part of the novel design) how it may be worn.

FIG. 5 is a bottom plan view of the appliance of FIG. 1.

FIG. 6 is an enlarged cross-sectional view of the tip of the appliance taken along line 6-6 of FIG. 2.

FIG. 7 is a perspective view of a preferred embodiment of the invention worn on a finger and being used with a PDA touchscreen interface to enter text.

FIG. 8 is a perspective view of a preferred embodiment of the invention shown being used while the user interfaces with a key of a keypad.

### DETAILED DESCRIPTION OF A PREFERRED EMBODIMENT

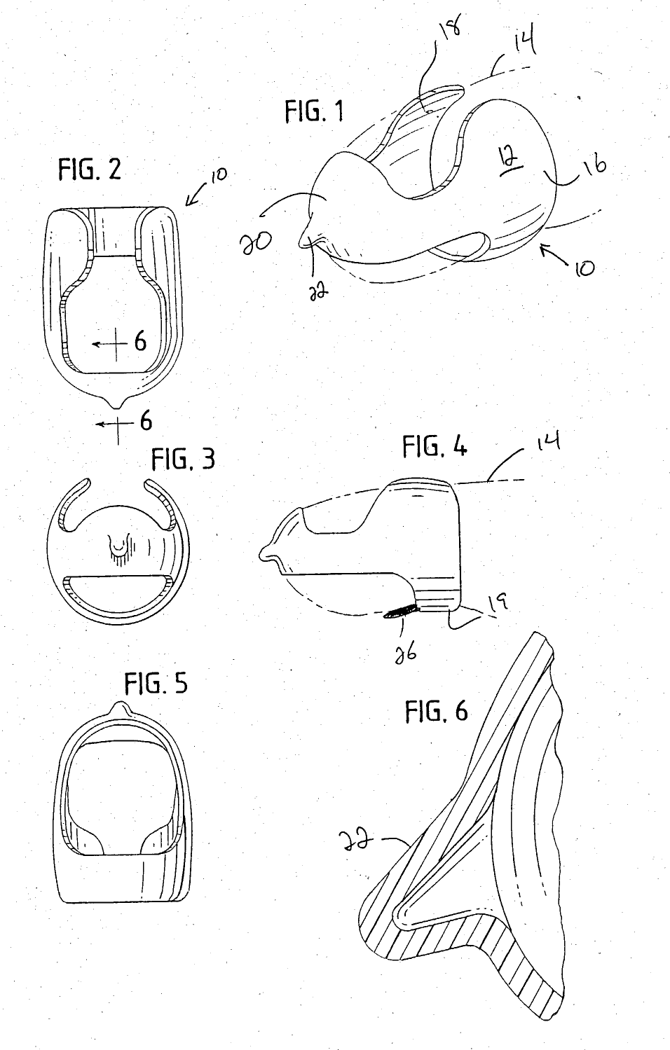

FIG. 1 shows the appliance 10 of the present invention worn on the finger of a user. Appliance 10 is a preferably unitary plastic body 12 forming a central cavity in which a user's finger 14 would reside during use. Body 12 is generally cylindrical in shape and has a left side 16 and right side 18 which conform generally to a finger. Sides 16 and 18 extend at least partially around the top of a finger for stability.

Appliance 10 also includes a distal portion 20. Distal portion 20 abuts the distal end of a finger and includes a blunt distal tip 22. Distal portion 20 abuts the end of a finger and includes a blunt distal tip 22. Distal tip 22 extends outwardly therefrom, preferably angled slightly downwardly to conveniently engage an input or interface device. As shown in FIG. 6, distal tip 22 is preferably an integral part of front portion 20 of appliance 10.

Distal tip 22 is sufficiently sharp at its outermost point to engage relatively small areas of a touchscreen device, but blunt such that it is not harmful in any way.

FIGS. 2 through 5 show appliance 10 from different views. Looking down on appliance 10 in FIG. 2 shows the open top and bottom of body 12. The top is open for convenience and to minimize any effect appliance 10 has on normal activity. The bottom of appliance 10 is open to allow a user to have unencumbered ability to touch and sense with his or her finger. As shown in FIG. 8, a user of appliance 10 can directly engage a key 28 of a keypad, or similarly adjust a volume control rotter or knob, etc. Furthermore, the respective top portions of right and left sides 16 and 18 are open for convenience, and to allow appliance 10 to snap onto a generally cylindrical device for storage when not in use.

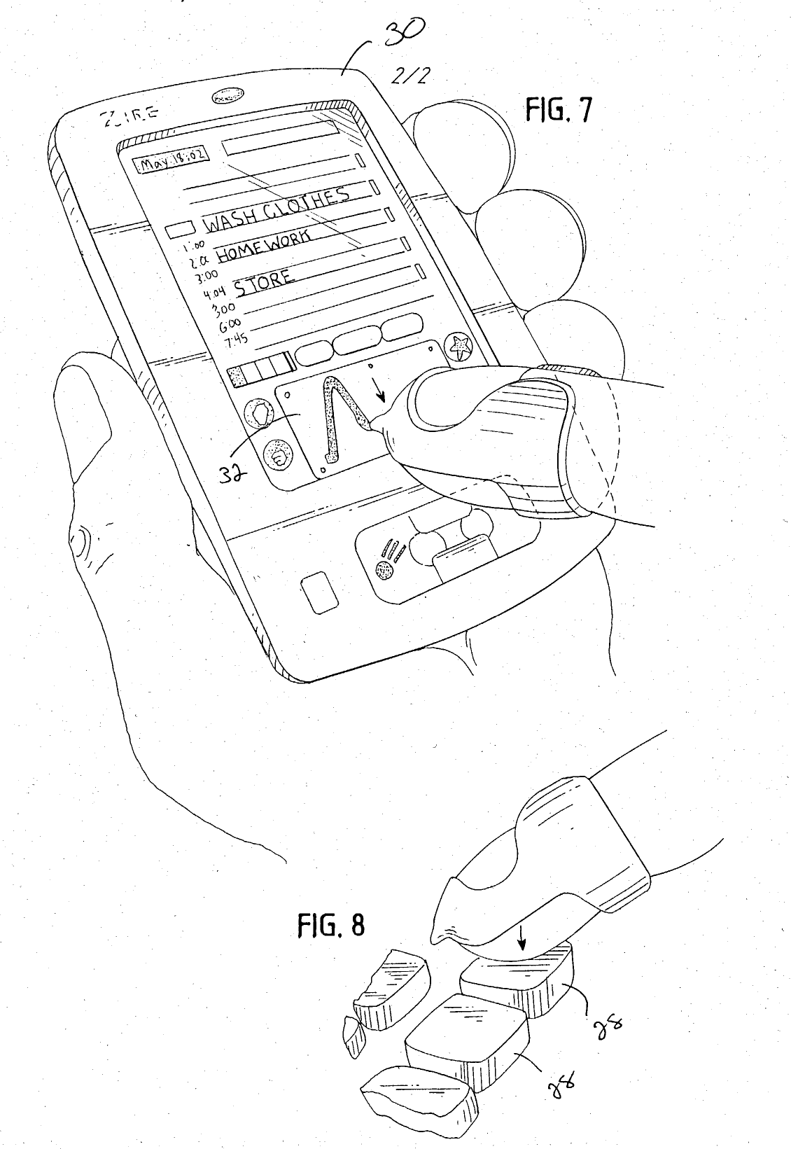

FIG. 7 shows appliance 10 in use with a popular personal digital assistant (“PDA”) device 30. As shown, distal tip 22 engages a touchscreen surface 32 to input data into the PDA. Further, where the PDA also includes buttons that can be activated by some physical force, appliance 10 allows the user to engage such buttons, or key 28, directly. This prevents the loss of touch sensation a user might otherwise have, and helps prevent any damage that may occur to a sensitive electronic key if the user lacked touch sensitivity.

Further, as shown in FIG. 4, appliance 10 may also preferably include tab 26 extending forwardly from the underside of body 12. As may be expected, in use some torque will be placed on appliance 10 as distal tip 22 engages a touchscreen surface. The torque will bias front portion 20 upwardly. Preferably, the inertia of appliance 10 snugly engaging the user's finger 14 will be more than sufficient to counter the relatively small torque. However, to ensure that appliance 10 remains in place in use, tab 26 can be used to resist the torque by, in effect, reducing the lever arm. Of course, if lower portion 19 of body 12 is fully enclosed, tab 26 is encompassed therein. If, however, lower portion 19 includes the opening to allow full touch sensitivity, tab 26 can be included to supplement the resistance to any torque.

Moreover, as best seen with reference to FIG. 6, distal tip 22 is preferably angled downwardly to allow the user to “write” on a touchscreen or elsewhere with the user's finger in an appropriately comfortable position. If the distal tip 22 extends directly outwardly substantially coaxially with body 12, which may be desirable in some instances, the user's finger may interfere with the user's line of sight, or require a non-instinctive or unnatural position of the finger when writing.

While the invention has been described with reference to a preferred embodiment, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A finger appliance adapted for interfacing with an electronic device and which can be removably worn on a human finger comprising:
a body having a front portion, at least one rearwardly-extending portion, and an opening at a rear end;
a sturdy tip extending from the front portion to interface with an electronic device; and
the rearwardly-extending portion sized and shaped to snugly engage a human finger.

2. The finger appliance of claim 1 further comprising an opening at the bottom of the body exposing the finger.

3. The finger appliance of claim 2 further comprising a tab extending from the body and into said opening to resist rotational movement of said body when in use.

4. The finger appliance of claim 1 wherein the body is plastic.

5. The finger appliance of claim 1 wherein the sturdy tip extends substantially coaxially from the body.

6. The finger appliance of claim 1 wherein the sturdy tip extends substantially non-coaxially from the body.
